(19) United States
(12) Patent Application Publication
(10) Pub. No.: US 2015/0254572 A1
(43) Pub. Date: Sep. 10, 2015

(54) RELEVANCE-ORDERING OF MESSAGES

(71) Applicant: Microsoft Corporation, Redmond, WA (US)

(72) Inventors: Sebastian Johannes Blohm, Cambridge (GB); Dmitriy Meyerzon, Bellevue, WA (US)

(73) Assignee: Microsoft Corporation, Redmond, WA (US)

(21) Appl. No.: 14/200,651

(22) Filed: Mar. 7, 2014

(51) Int. Cl. G06N 99/00; G06F 17/30

(52) U.S. Cl. CPC G06N 99/005; G06F 17/3053; G06F 17/30867

(57) ABSTRACT

Technologies are described herein for ordering messages. A computer-implemented method for ordering of messages may include collecting training data related to users of a messaging system, generating a label for a message, generating feature values based on the training data and the message, and training a relevance model based on the feature values using a machine learning algorithm. The relevance model is configured to rank new message candidates received by the messaging system for display by the messaging system.

### BACKGROUND

Generally, news aggregators, social networks, and other online services may post messages and replies to messages for review by a user. Received messages are typically posted in order of receipt. Some systems may take message flags, such as “urgent” or other attributes, into consideration when displaying messages. For example, messages containing flags may be shown out of order such that a user or recipient may review these messages first.

Conventional mechanisms for posting messages may, however, fail to intelligently order messages. For example, a user may receive many messages to be reviewed. Absent intelligent-ordering, even if a user were to review several of the received messages, relevant messages may be displayed out-of-order or outside the bounds of a viewing pane in a user interface. As a consequence, a user may miss these relevant messages.

It is with respect to these and other considerations that the disclosure made herein is presented.

### SUMMARY

Technologies are described herein for ordering of received messages and/or replies to messages based upon a computed relevance to a user. In particular, user actions related to messages and/or replies to messages on a message posting server (e.g., email server, social network, etc.) may be considered in the creation of a ranking model for processing of future messages. The ranking model may be used to rank newly received messages for more meaningful display to a user.

According to one embodiment presented herein, a computer-implemented method includes collecting training data related to users of a messaging system. The training data is related to at least one message stored on the messaging system. The method also includes generating at least one label for the at least one message. The at least one label is associated with a relevancy of the at least one message to users of the messaging system. The method also includes generating a plurality of feature values based on the training data and the at least one message. The plurality of feature values indicate a different aspect of possible relevancy of the at least one message to the users of the messaging system. Finally, the method also includes training a relevance model based on the plurality of feature values and the at least one label using a machine learning algorithm. The relevance model is configured to rank new message candidates received by the messaging system.

According to another embodiment presented herein, a computer includes a processor and a computer-readable storage medium in communication with the processor. The computer-readable storage medium has computer-executable instructions stored thereupon which, when executed by the processor, cause the processor to collect training data related to users of a messaging system, generate a plurality of feature values based on the training data, training a relevance model based on the plurality of feature values using a machine learning algorithm, rank the new message candidates based on the relevance model to create a set of ranked messages, and output the ranked messages through the messaging system.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a network diagram showing aspects of an illustrative operating environment and several software components provided by the embodiments presented herein;

FIG. 1B is a network diagram showing aspects of an illustrative operating environment and several software components provided by the embodiments presented herein;

FIG. 2 is a user interface (UI) diagram showing an exemplary UI provided in one embodiment presented herein;

FIG. 3 is a flowchart showing aspects of one illustrative routine for performing offline processing to produce a relevance model, according to one embodiment presented herein;

FIG. 4 is a flowchart showing aspects of one illustrative routine for performing runtime processing to rank and/or display messages based on a relevance model, according to one embodiment disclosed herein;

FIG. 5 is an exemplary table depicting information related to received messages prior to relevance-ordering;

FIG. 6 is a state transition diagram depicting aspects of an exemplary relevance model;

FIG. 7 is a UI diagram showing aspects of an portion of an exemplary UI for displaying relevance-ordered replies and/or messages; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for ordering of information posted through a server. Through the use of the technologies and concepts presented herein, messages, replies, and other information submitted to a message posting server may be intelligently ordered based on relevance or a calculated relevance to a recipient or target audience. The intelligent ordering may maximize a utility function representative of a user's usage, satisfaction, or overall engagement with a messaging system. For example, a degree of relevance of a message for a recipient may be substantially different than that of the transmitter. Therefore, although a transmitter may conventionally flag a message as relevant, urgent, or otherwise, the recipient may not consider the message actually or currently relevant. In contrast, the recipient's interaction with messages from the same transmitter may be a better indication of how relevant messages originating from the same transmitter may be in the future. Furthermore, relevance of messages sent by the same transmitter to a recipient may vary over time.

Additionally, a group or target audience's interaction with messages from the same transmitter, or messages with similar attributes to those previously interacted with, may be a better indication of how messages with similar attributes will be interacted with in the future. As such, exemplary embodiments disclosed herein provide program modules, systems, and processes by which information submitted to a server may be ordered (or ranked) prior to display to a recipient or target audience based on the above criteria and other criteria.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for relevance-ordering of messages will be described.

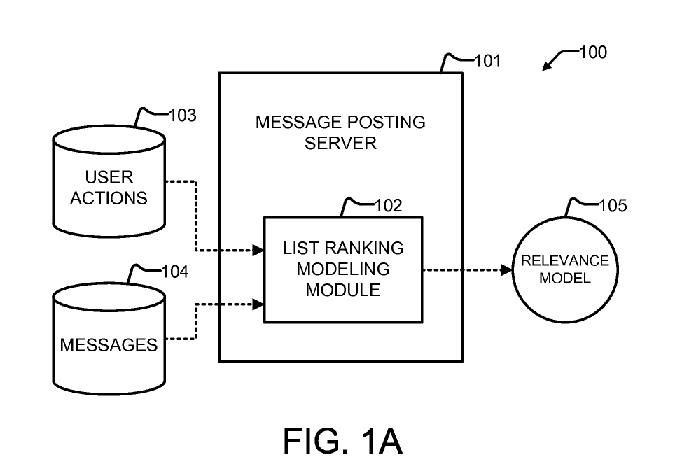

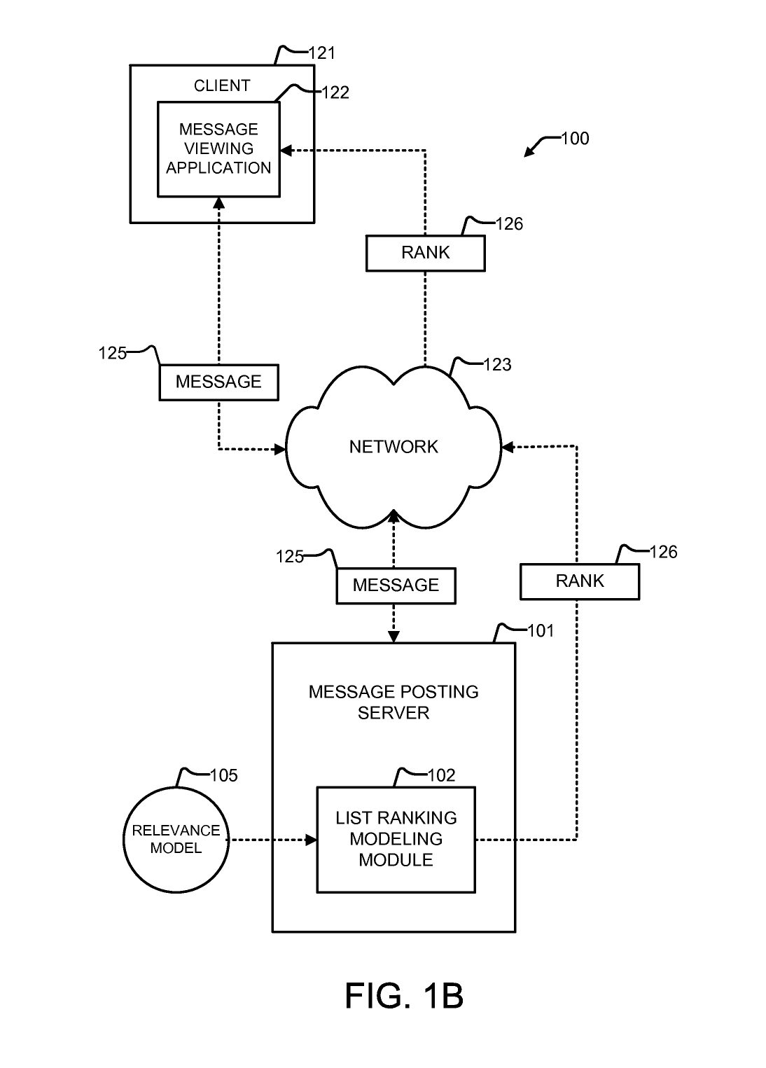

Turning now to FIGS. 1A and 1B, details will be provided regarding an illustrative operating environment and several software components provided by the embodiments presented herein. Generally, FIG. 1A depicts a portion of several modules and components utilized during offline processing of information, and FIG. 1B depicts several modules and components utilized during runtime processing of information. In particular, FIG. 1A shows aspects of a system 100 for relevance-ordering of messages during offline processing. The system 100 includes a message posting server 101. The message posting server 101 may include any suitable server having hardware components configured to execute program modules and/or computer-executable instructions. For example, the message posting server 101 may include a single dedicated computer server, a plurality of computer servers, or any combination of dedicated and plural computers configured to process information stored on or received across a network. The message posting server 101 may have software or program modules stored and executed thereon, such as, a list ranking modeling module 102.

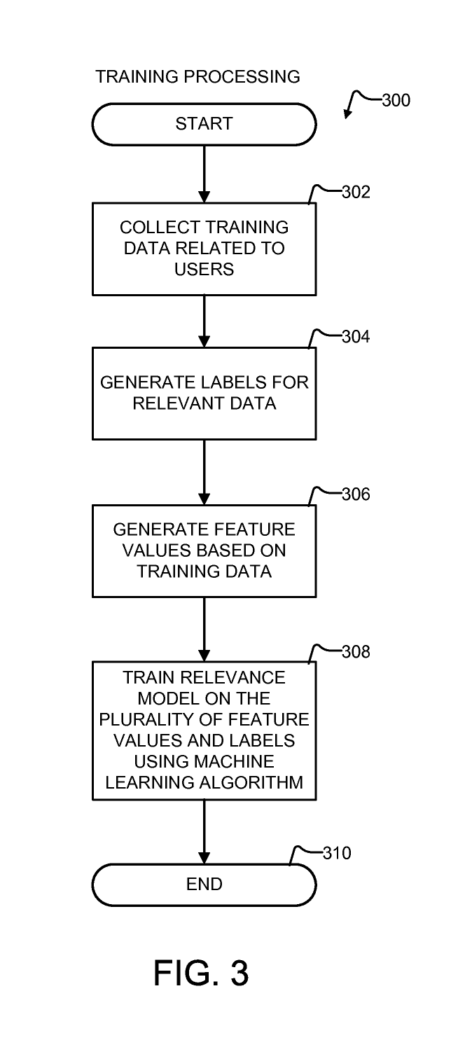

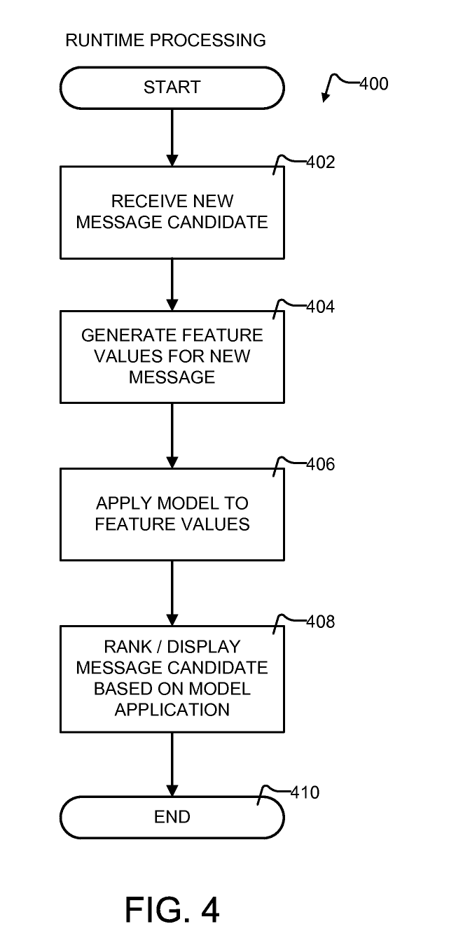

The list ranking modeling module 102 may include computer executable instructions which, when executed by a computer processor of the message posting server 101, direct the computer processor to perform any methodology described herein, including those processes which are described more fully with reference to FIGS. 3 and 4. Generally, the list ranking modeling module 102 receives information related to user actions 103 and messages 104, and processes the same to train and output a relevance model 105.

User actions 103 may include data or information related to user actions taken with regard to messages provided by a messaging system. For example, and without limitation, user actions 103 may include replies, clicks, private responses, comments, saves, deletions, or other suitable actions a user of a messaging system may perform as related to one or more messages or groups of information. According to at least one embodiment, user actions 103 including replies and likes are more indicative of the relevancy of a message. Furthermore, according to some embodiments, user actions 103 may also include absence of interaction, for example, through indication of how a user interacted or did not interact with a received and read message. Lack of interaction may be used in determining a “bad” or “poor” label for training Messages 104 may include data or information related to messages (or any other form of communication) sent through a messaging system. For example, and without limitation, messages 104 may include status updates from a social networking platform, posts from the social networking platform, electronic mail messages (email), links to information on a network, or any other suitable information transmittable to a recipient or target audience. According to at least one embodiment, messages 104 also include message information including message text, recipient, transmitter, and a position on a message thread (e.g., first, last, etc.).

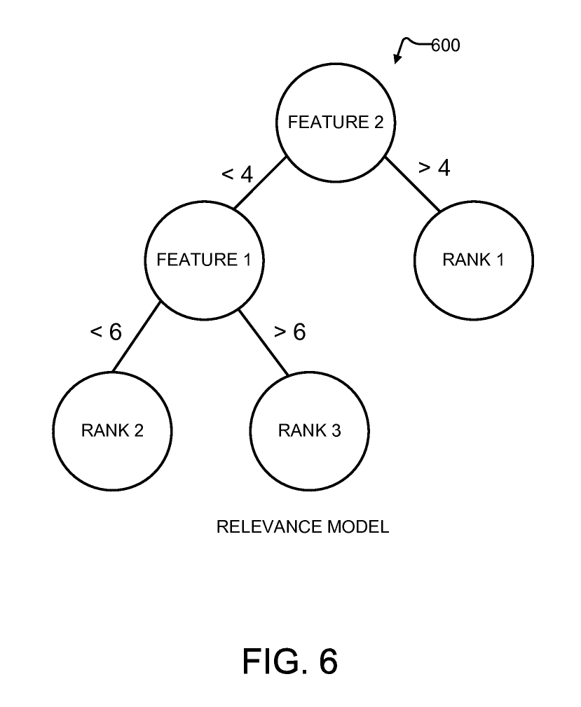

The relevance model 105 may include any suitable model for determining a relevance of a message prior to posting through a messaging system for review by a recipient or target audience. According to at least one exemplary embodiment, the relevance model 105 includes a decision tree. The decision tree may include a plurality of decisions trees, each having a plurality of ranking leaves determining a rank for a particular set of feature values for any message processed through the messaging system. Additional details regarding the decision tree will be provided below with regard to FIG. 6.

It is noted that although described above as related to messages, any form of targeted information is applicable to exemplary embodiments disclosed herein. For example, links to news articles, company memorandums, promotional material, and other information may be suitably ranked, sorted, and displayed according to some exemplary embodiments. This may be facilitated through creation of at least an initial relevance model 105 during training processing (or at initial runtime in some embodiments) which can be used during runtime to determine a ranking for information.

Turning now to FIG. 1B, additional aspects of the system 100 for relevance-ordering of messages during runtime processing will be provided. As shown in FIG. 1B, the message posting server 101 includes the list ranking modeling module 102 being executed thereon, and taking as input the relevance model 105 formed during offline processing as described in FIG. 1A.

The system 100 illustrated in FIG. 1B further includes a client computer 121 having a message viewing application 122 executed and/or stored thereon. The client computer 121 may be any suitable computer, including, but not limited to, a personal computer apparatus having at least one computer processor, a table computer, a notebook computer, a mobile telephone, a personal digital assistant, or any other suitable computer.

The message viewing application 122 may include computer executable instructions that, when executed by a processor of the client computer 121, direct the processor to provide messages 125 received from the message posting server 101 according to a relevance-ordering rank 126 described herein. For example, the message viewing application 122 may render a user interface that allows a user to view one or more messages 125 in a list or other format which has been ordered according to relevance as computed in the manner presented herein. Generally, these messages may be received from the message posting server 101 over a network 123 along with an associated relevance-ordered rank 126. As described above, the message 125 may be embodied as any suitable form of information. However, for simplicity of discussion the term “message” is used herein to refer to any form of communication sortable through the message posting server 101.

The relevance-ordered rank 126 may be a numerical value utilized to sort the message 125 upon receipt or through rendering at the message viewing application 122. For example, according to at least one exemplary embodiment, the relevance-ordered rank 126 is a numerical value representing a place (e.g., “0”) on a relevance-ordered list where a message should be displayed to a user or target audience. According to other exemplary embodiments, the relevance-ordered rank 126 is an offset (e.g., “+/−0”) representative of how far removed a message should be displayed from an origin or top of a listing of information to be provided to a user or target audience.

Generally, as messages 125 are sent from other client computers not particularly illustrated through network 123 to message posting server 101, the list ranking modeling module 102 may use the relevance model 105 to create the relevance-ordered rank 126 for the messages, and provide both the messages 125 and the relevance-ordered rank 126 to an associated target for display or output in another manner to a user through a user interface, for example.

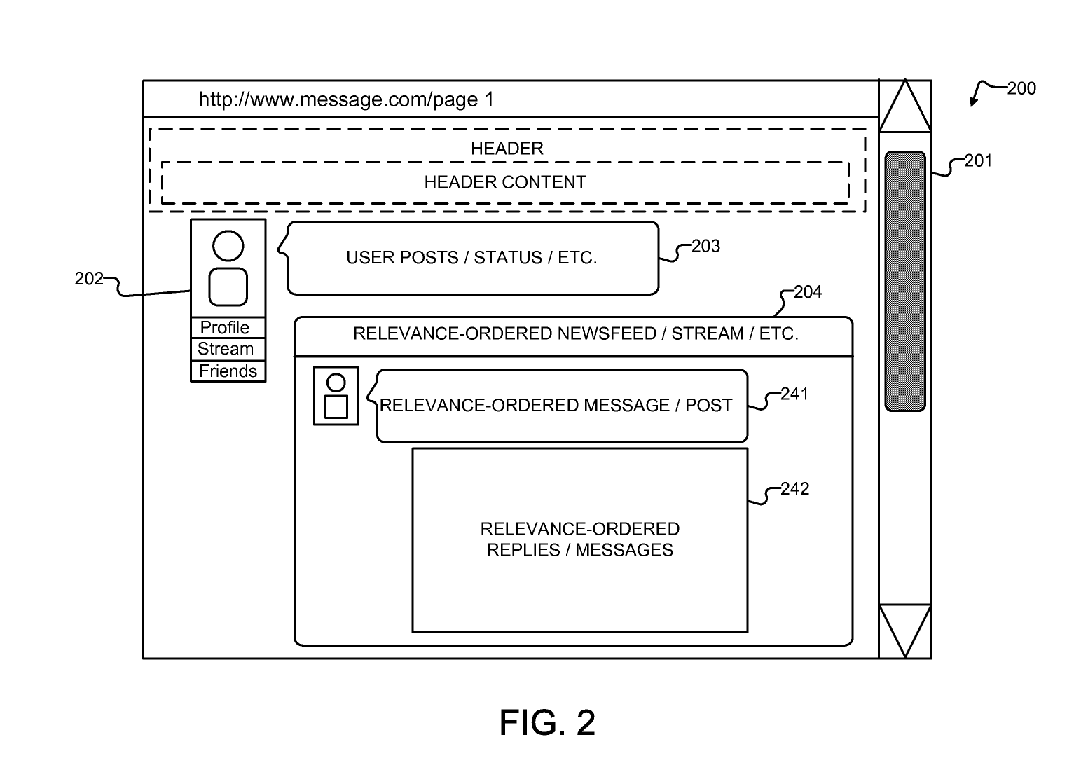

Turning now to FIG. 2, an exemplary user interface 200 for presenting rank-ordered messages will be described. As shown in FIG. 2, the user interface 200 may include a user interface rendering 201, represented in FIG. 2 as a conventional application window provided by a Web browser application. It should be understood that the user interface rendering 201 can take any desired form, and thus should not be limited solely to the example illustrated in FIG. 2.

The user interface 200 may include interface elements rendered as part of the rendering 201. For example, a user profile designation 202 may be included that identifies a user through a profile picture and provides options for viewing received information (e.g., profile information, message stream information, friend information, etc.). Information may be submitted by the user through an active interface portion 203 configured to receive messages or other information to be posted on behalf of the user through a message posting server 101. Furthermore, messages or other information received for the user may be displayed through a relevance-ordered news stream, feed, or other element 204. For example, messages 241 and 242 may be displayed for review and interaction by the user, and may include a plurality of options that may be taken by the user with regard to the messages (e.g., reply to message, save message, like message, comment on message, send private communication to transmitter of message, etc.). User actions in response to these options may be stored for use during training or runtime processing for creation of new or updated relevance models.

Referring now to FIG. 3, additional details will be provided regarding the embodiments presented herein for creation or updating of relevance models. In particular, FIG. 3 is a flow diagram illustrating aspects of the training processing operation of one or more portions of a message posting server (e.g., 101). The flow diagram illustrates a method 300, of prioritizing, determining relevance, and/or otherwise training a relevance model 105 for sorting of messages and information processed by a message posting server 101.

As illustrated, the method 300 includes collecting training data related to users of a messaging system at block 302. The training data may include user actions 103 or any other suitable data that is related to at least one message 125 stored on the messaging system. For example, according to one exemplary embodiment, the training data includes a measure of user interactions with the message. Additionally, the training data can include a measure of interactions with other messages, or may include a measure of interactions for groups of messages associated with a particular transmitter.

Generally, the measure of user interactions includes an amount of time a user reviews the at least one message, a number of responses to the message, a number of re-postings of the message, a value representing whether any user liked or disliked the message, an age of the message, a time at which the message was sent, a number of interactions between a user creating the message and other users of the messaging system, a number of interactions between the user creating the message and groups of users of the messaging system, a number of interactions between a user viewing the message and other users of the messaging system, and a number of interactions between the user viewing the message and groups of users of the messaging system. Any of these measures may be time-decayed to increase an accuracy of a resulting trained relevance model. For example, a number of responses and interactions with a message may be time-decayed such that older responses are weighted less than more recent responses in training a relevance model. Such may be facilitated through a sum of decayed interactions based on the age of each interaction, or any other suitable time decay calculation.

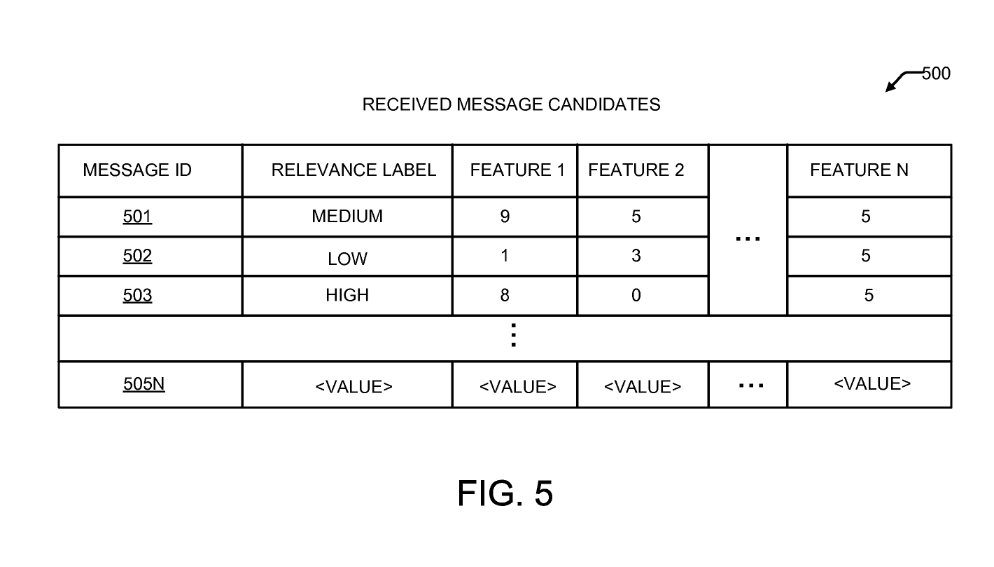

Upon collecting the training data at block 302, the method 300 further includes generating a label for the message at block 304. Generally, the label is associated with a relevancy of the message to a user or users of the messaging system and may be termed a relevance label as shown in FIG. 5. For example, the label may be a value associated with a measure of the relevancy of the at least one message. This measure of relevance can include one or more measures of whether a user “liked” a message and replied to a message. These measures indicate how a user or users have interacted with the message, and therefore are likely partial indicators of how relevant a message from the same transmitter in the future may be.

Upon generating the label at block 304, the method 300 further includes generating feature values based on the training data and the message information at block 306. The feature values generally indicate a numerical measure of relevancy of the message to the users of the messaging system. For example, the feature values may represent a variety of features contained in any message.

Turning to FIG. 5, an exemplary table showing message candidates is presented. As illustrated, messages 501-505N may include a relevance label (e.g., as created at block 304), and feature values FEATURE 1, FEATURE 2, . . . , FEATURE N associated therewith. The feature values may include an interaction count between a recipient and transmitters of messages, interaction count between a recipient and groups of users, recency of the message, count of other actions a recipient performs in the messaging system, a measure of previous engagement between users and a target thread of messages in the messaging system, and/or any other suitable feature values which can be measured in a messaging system. Although illustrated in FIG. 5 as representative of received message candidates, it should be understood that the table 500 may also represent stored messages and associated training data related thereto for creation of a relevance model as described herein.

Turning back to FIG. 3, upon generating the plurality of feature values at block 306, the method 300 further includes training the relevance model 105 based on the plurality of feature values using a machine learning algorithm at block 308. The training may include a training process that takes as input the plurality of feature values and relevance labels, and as output produces the relevance model 105 that optimizes a precision metric of message lists ordered according to the relevance model 105. The relevance model 105 is configured to rank new message candidates (e.g., such as those illustrated in FIG. 5) received by the messaging system 100. For example, the machine learning algorithm may take into consideration training data arranged somewhat similar to table 500, and based on these feature values, labels, and a machine learning algorithm, output a new or updated relevance model 105 by which to rank or sort incoming messages at runtime.

According to some embodiments, the machine learning algorithm includes a boosted decision tree, a gradient boosted decision tree, a RankNet algorithm, a LambdaRank algorithm, or a LambdaMART algorithm. One or more of these algorithms may use training data as an input to determine an appropriately weighted model such as the exemplary model illustrated in FIG. 6. As illustrated, the relevance model 600 includes a weighted decision tree by which to rank incoming messages at runtime based on calculated / determined feature values for FEATURE 1 and FEATURE 2.

It should be appreciated that although the simplified decision tree 600 illustrates only two feature values being used for ranking, that any number of feature values may be used according to any desired implementation. Therefore, the scope of this disclosure should not be limited to the particular number of nodes illustrated. As described above, the model 600 may be generated using a machine learning algorithm, including any of the examples listed above. Furthermore, any of these machine learning algorithms may include a number of boosted decision trees to aid in formulation of the model 600. For example, according to one embodiment, the machine learning algorithm includes two or more boosted decision trees based on feature values, and wherein each boosted decision tree decision trees includes a number of ranking leaves determining a rank for a particular set of feature values.

Finally, upon training the relevance model 105 based on the feature values and labels at block 308, the method 300 concludes at block 310. It is noted that the method 300 may include more or less steps than those illustrated, including, for example, runtime steps configured to rank and/or sort incoming messages. For example, the method 300 may include, according to some embodiments, receiving a new message for display through the messaging system 100, generating feature values for the new message, applying the feature values for the new message to the relevance model, and ranking or displaying the new message based on application of the feature values for the new message.

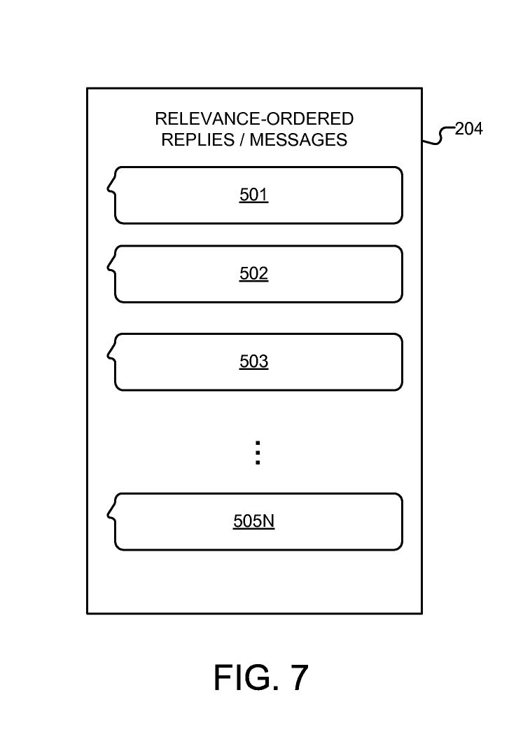

Returning to the example set forth above with reference to table 500, if feature values associated with messages 501-505N are applied to model 600, an associated or appropriate output display may include the user interface element 204 arranged as illustrated in FIG. 7. As shown in FIG. 7, messages 501-505N have been ordered based on relevance to a particular user upon ranking with model 600.

Referring now to FIG. 4, additional details will be provided regarding the embodiments presented herein for ranking messages using relevance models during runtime. In particular, FIG. 4 is a flow diagram illustrating aspects of the runtime processing operation of one or more portions of a message posting server (e.g., 101). The flow diagram illustrates a method 400, of prioritizing, determining relevance, and/or otherwise sorting of messages 125 and information processed by a message posting server 101.

As illustrated, the method 400 includes receiving a new message candidate for display to a user at block 402. The new message candidate may include any suitable form of message or information as set forth in the examples above. For example, according to some embodiments, a new message candidate includes a message, a link to information, or a social networking status. This new message candidate may be received at a message posting server 101 over a network 123 from a client computer 121.

Upon receiving the message candidate at block 402, the method 400 further includes generating feature values for the received message candidate at block 404. For example, and as illustrated in FIG. 5, each message 501-505N may be processed to generate feature values associated with message features. These feature values may include any suitable measurements or counts, including, for example, an interaction count between a recipient and transmitters of messages, interaction count between a recipient and groups of users, recency of the received message, count of other actions a recipient performs in the messaging system, a measure of previous engagement between users and a target thread of messages in the messaging system, and/or any other suitable feature values which can be measured in a messaging system. Generally, the feature values generated at block 404 match those feature values used to train the relevance model 105.

Upon generating feature values at block 404, the method 400 further includes applying a relevance model to the generated feature values at block 406 and ranking the message candidate based on application of the relevance model at block 408. For example, the model 600 may have been generated during offline processing as described above, and may be used as an input model for method 400.

Each feature value generated at block 404 may be used as inputs to traverse the model 600 such that a particular ranking value (e.g., RANK 1, RANK 2, RANK 3, . . . , RANK N) is determined for each received message candidate 501-505N. Generally, each particular ranking value is a number on a continuous scale that can be used for message sorting. According to some embodiments, this includes supplying relevance-ordered ranking values determined through blocks 406-408 and a copy of the message to a client computer as illustrated in FIG. 1B. Display of the relevance-ordered messages may be organized somewhat similarly to the user interface element 204 of FIG. 7, or may be arranged in any meaningful manner.

Finally, after ranking and displaying the message candidate at block 408, the method 400 concludes at block 410. Alternatively, the method 400 may continually iterate as new messages are received (not illustrated).

It should be appreciated that the logical operations described above may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

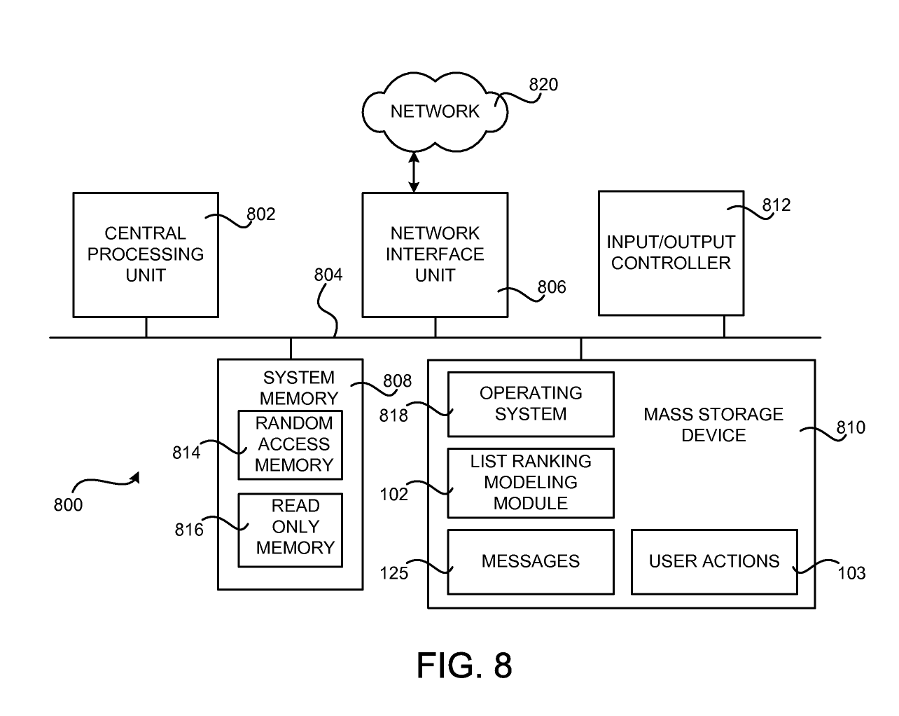

FIG. 8 shows an illustrative computer architecture for a computer 800 capable of executing the software components described herein for relevance-ordering of messages in the manner presented above. The computer architecture shown in FIG. 8 illustrates a conventional desktop, laptop, or server computer and may be utilized to execute any aspects of the software components presented herein described as executing on the client computer 121 or the message posting server 101.

The computer architecture shown in FIG. 8 includes a central processing unit 802 (“CPU”), a system memory 808, including a random access memory 814 (“RAM”) and a read-only memory (“ROM”) 816, and a system bus 804 that couples the memory to the CPU 802. A basic input/output system containing the basic routines that help to transfer information between elements within the computer 800, such as during startup, is stored in the ROM 816. The computer 800 further includes a mass storage device 810 for storing an operating system 818, application programs, and other program modules, which are described in greater detail herein.

The mass storage device 810 is connected to the CPU 802 through a mass storage controller (not shown) connected to the bus 804. The mass storage device 810 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 800. For purposes of the claims, the phrase “computer storage medium,” and variations thereof, does not include waves or signals per se and/or communication media.

According to various embodiments, the computer 800 may operate in a networked environment using logical connections to remote computers through a network such as the network 820. The computer 800 may connect to the network 820 through a network interface unit 806 connected to the bus 804. It should be appreciated that the network interface unit 806 may also be utilized to connect to other types of networks and remote computer systems. The computer 800 may also include an input/output controller 812 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 810 and RAM 814 of the computer 800, including an operating system 818 suitable for controlling the operation of a networked desktop, laptop, or server computer. The mass storage device 810 and RAM 814 may also store one or more program modules, such as the list ranking modeling module 102, described above. The mass storage device 810 and the RAM 814 may also store other types of program modules and data, such as the messages 125 and the user actions 103.

Based on the foregoing, it should be appreciated that technologies for relevance ordering of messages and other types of information are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method, the method comprising:
collecting training data related to users of a messaging system, the training data being related to at least one message stored on the messaging system;
generating at least one label for the at least one message, the at least one label being associated with a relevancy of the at least one message to users of the messaging system;
generating a plurality of feature values based on the training data and the at least one message, the plurality of feature values indicating a numerical measure of relevancy of the at least one message to the users of the messaging system; and
training a relevance model based on the plurality of feature values and the at least one label using a machine learning algorithm, the relevance model configured to rank new message candidates received by the messaging system.

2. The method of claim 1, wherein the training data comprises at least one measure of user interaction with the at least one message.

3. The method of claim 2, wherein the measure of user interaction includes time-decayed measures of responses to and interactions with the at least one message.

4. The method of claim 2, wherein the measure of user interaction includes at least one of:
an amount of time a user reviews the at least one message;
a number of responses to the at least one message;
a number of re-postings of the at least one message;
a value representing whether any user liked or disliked the at least one message;
an age of the at least one message;
a time at which the at least one message was sent;
a number of interactions between a user creating the at least one message and other users of the messaging system;
a number of interactions between the user creating the at least one message and groups of users of the messaging system;
a number of interactions between a user viewing the at least one message and other users of the messaging system; and
a number of interactions between the user viewing the at least one message and groups of users of the messaging system.

5. The method of claim 4, wherein the numerical measure for each feature value of the plurality of feature values is based on the measure of user interaction with the at least one message.

6. The method of claim 1, wherein the at least one label is a numerical value associated with a measure of the relevancy of the at least one message.

7. The method of claim 6, wherein the measure of the relevancy of the at least one message includes at least one of:
a number of times a user replies to the at least one message; and
a number of times a user likes the at least one message.

8. The method of claim 1, further comprising:
receiving a new message for display through the messaging system; and
displaying the new message based on a ranking obtained through the relevance model.

9. The method of claim 1, further comprising:
receiving a new message for display through the messaging system;
generating feature values for the new message;
applying the feature values for the new message to the relevance model; and
ranking or displaying the new message based on application of the feature values for the new message.

10. The method of claim 1, wherein the machine learning algorithm includes at least one of a boosted decision tree, a gradient boosted decision tree, a RankNet algorithm, a LambdaRank algorithm, or a LambdaMART algorithm.

11. The method of claim 10, wherein the machine learning algorithm includes a plurality of decision trees based on a plurality of feature values, and wherein each decision tree of the plurality of decision trees includes a plurality of ranking leaves determining a rank for a particular set of feature values.

12. A computer-implemented method, the method comprising:
collecting training data related to users of a messaging system, the training data being related to messages stored on the messaging system;
generating a plurality of feature values based on the training data, the plurality of feature values indicating a numerical measure of relevancy of the messages to the users of the messaging system;
training a relevance model based on the plurality of feature values using a machine learning algorithm, the relevance model configured to rank new message candidates received by the messaging system;
ranking the new message candidates based on the relevance model to create a set of ranked messages; and
outputting the ranked messages through the messaging system.

13. The method of claim 12, wherein the training data comprises measures of user interactions with the messages.

14. The method of claim 13, wherein the measures of user interactions includes at least one of:
an amount of time a user reviews a message;
a number of responses to a message;
a number of re-postings of a message;
a value representing whether any user liked or disliked a message;
an age of a message;
a time at which a message was sent;
a number of interactions between a user creating a message and other users of the messaging system;
a number of interactions between the user creating a message and groups of users of the messaging system;
a number of interactions between a user viewing a message and other users of the messaging system; and
a number of interactions between the user viewing a message and groups of users of the messaging system.

15. The method of claim 14, wherein the numerical measure for each feature value of the plurality of feature values is based on the measure of user interactions with the at least one message.

16. The method of claim 12, wherein ranking the new message candidates comprises:
receiving a new message for display through the messaging system;
generating feature values for the new message;
applying the feature values for the new message to the relevance model; and
ranking the new message based on application of the feature values for the new message.

17. The method of claim 12, wherein the machine learning algorithm includes at least one of a boosted decision tree, a gradient boosted decision tree, a RankNet algorithm, a LambdaRank algorithm, or a LambdaMART algorithm.

18. The method of claim 17, wherein the machine learning algorithm includes a plurality of decision trees based on a plurality of feature values, and wherein each decision tree of the plurality of decision trees includes a plurality of ranking leaves determining a rank for a particular set of feature values.

19. A computer, comprising:
a processor; and
a computer-readable storage medium in communication with the processor, the computer-readable storage medium having computer-executable instructions stored thereupon which, when executed by the processor, cause the processor to
collect training data related to users of a messaging system, the training data being related to messages stored on the messaging system,
generate a plurality of feature values based on the training data, the plurality of feature values indicating a numerical measure of relevancy of the messages to the users of the messaging system,
train a relevance model based on the plurality of feature values using a machine learning algorithm, the relevance model configured to rank new message candidates received by the messaging system,
receive a new message candidate for display through the messaging system,
generating feature values for the new message candidate,
rank the new message candidate based on the relevance model and the feature values for the new message candidate to create a message rank, and
output the new message candidate and the message rank through the messaging system.

20. The computer of claim 19, wherein the machine learning algorithm includes at least one of a boosted decision tree, a gradient boosted decision tree, a RankNet algorithm, a LambdaRank algorithm, or a LambdaMART algorithm.
